(19) United States
(12) Patent Application Publication
(10) Pub. No.: US 2001/0056342 A1
(43) Pub. Date: Dec. 27, 2001

(54) Voice enabled digital camera and language translator

(76) Inventors: Thomas Barry Piehn, Moorpark, CA (US); Allison Dianne Piehn, Moorpark, CA (US)

Correspondence Address: Thomas B. and Allison D. Piehn, 12177 Cherrygrove St., Moorpark, CA, 93021, US

(21) Appl. No.: 09/789,220

(22) Filed: Feb. 20, 2001

Related U.S. Application Data
(60) Provisional application No. 60/184,835, filed on Feb. 24, 2000.

(51) Int. Cl. G06F 17/28; G10L 21/00

(52) U.S. Cl. 704/3; 704/2; 704/271; 704/277

(57) ABSTRACT

A digital camera that recognizes printed or written words, and converts those words into recognizable speech in either native or foreign tongue. The user points the camera at a printed/text object and the camera will speak (or optionally display) the words. Using this device, a blind or visually disabled person can point at an object, press the shutter button to “take a picture” of the words before him/her, and the camera will speak those words in his/her native language. In a second and more advanced configuration, a person can point this camera at a worded object, press the shutter button to “take a picture” of the words before him/her and the camera will speak those words in a foreign language. Alternatively, he/she may point at text in a foreign language and have those words translated and spoken in his/her native language. This camera includes resident software that: a) captures the digital image, b) uses OCR (Optical Character Recognition) software/algorithms to detect written words (text) within the image, c) converts the text from the language A to language B, and either: c1) use text-to-speech (TTS) software to synthesize speech and audibly “speak” the words to you, or c2) display the words on a display screen in Language B.

### CROSS-REFERENCE TO RELATED APPLICATIONS

U.S. Provisional patent application, Title: Voice Enabled Digital Camera/Image Sensor Device and Language Translator. Application No. 60/184,835, Filed Feb. 24, 2000.

A digital camera that recognizes printed or written words, and converts those words into recognizable speech in either native or foreign tongue. The user points the camera at a printed/text object and the camera will speak (or optionally display) the words.

Using this device, a blind or visually disabled person can point at an object containing words or text, press the shutter button to “take a picture” of the words before him/her, and the camera will speak those words in his/her native language. The camera includes resident software that: a) captures the digital image, b) uses OCR (Optical Character Recognition) software/algorithms to detect written words (text) within the image, and c) use text-to-speech (TTS) software to synthesize speech and audibly “speak” the words.

In a second and more advanced configuration, a person can point this camera at a worded object, press the shutter button to “take a picture” of the words before him/her and the camera will speak those words in a foreign language. Alternatively, he/she may point at text in a foreign language and have those words translated and spoken in his/her native language. This camera includes resident software that: a) captures the digital image, b) uses OCR (Optical Character Recognition) software/algorithms to detect written words (text) within the image, c) converts the text from the language A to language B, and either: c1) use text-to-speech (TTS) software to synthesize speech and audibly “speak” the words to you, or c2) display the words on a display screen in Language B.

### STATEMENT REGARDING FEDERALLY SPONSORED RESEARCH OR DEVELOPMENT

No aspect of this invention was made, researched, or developed under federally sponsored research and development. A patent search (for related, or similar inventions) was conducted and partially funded by a grant from the California Associated for the Gifted (CAG) Student grant.

### REFERENCE TO A MICROFICHE APPENDIX

Not Applicable

### BACKGROUND OF THE INVENTION

The present invention pertains to two fields. In its most basic mode, the present invention pertains to reading assistance for the visually impaired. In a more advanced configuration, the present invention pertains to language translation. The former mode (reading mode) is a subset of the latter (translating mode). The physical appearance and mechanical nature of the present invention closely resembles a common point-and-shoot film camera. The operation of the present invention (from the users perspective) is based upon a film-camera paradigm. The electronic architecture of the present invention resembles that of a digital camera, with significant differences, however, in that the present invention embodies embedded firmware and software relevant to the specific functions (reading and translation) performed by this invention. Unlike a film or digital camera, however, the present invention neither takes, nor stores pictures or images. The present invention is a unique integration of hardware and software in a device that “reads” physical objects (text-based) and “speaks” the words in either native or select foreign language.

The present invention is the subject of a provisional patent application (Application number 60/184,835) dated Feb. 24, 2000. The fundamental mode of the present invention has been demonstrated (using laboratory equipment and hardware) in several public forums. The concept of a camera-like device that can recognize text and “speak” those words was demonstrated in public forums three times in 1999.

| Venue | Date | Reference |
|---|---|---|
| Chaparral Middle | Feb 24, 1999 | None |
| School, Moorpark, | | |
| CA | | |
| Ventura County | 4/29-5/1/99 | http://www.west.net/˜vcsf/ |
| Science Fair, | | wincat99.htm |
| Ventura, CA | | |
| California State | 5/24-5/27/99 | http://www.usc.edu/CSSF/History/ |
| Science Fair- | | 1999/J11.htm1 |
| Los Angeles, CA | | Project # J1119 |

A provisional patent application was filed on the one-year anniversary of the first public-disclosure in accordance with U.S. Patent and Trademark Office guidelines.

A review of prior art and similar technology reveals a number of inventions striving to assist the visually impaired to read or recognize text. Most of these devices are contact based. (i.e. They require physical contact with the object to be read.) They are commonly scanner-based inventions able to scan sheets of paper or magazine copy. Indeed, the early phases of the development of the present invention began by using both flatbed and sheet feed scanners using a personal computer as a development engine. A review of prior devices indicates that these devices, in fact, work but are tactile intensive. The user must manipulate both objects and computer. The manipulation of object and equipment almost presupposes that the operator is sighted.

The development of the present invention included interaction with and observation of persons who were partially sighted and fully blind. It became apparent that there is a need for a small, simple, portable, easy-to-use, affordable device or appliance to help the visually impaired to read text based objects without actually contacting, or knowing the precise location of the object of interest.

The development of the present invention included a survey of products presently available in the market place. It is readily apparent that products for the blind, or visually disabled are very costly. Products for the visually disabled (both hardware and software) are easily an order of magnitude more costly than products of similar complexity (similar in terms of complexity, but not necessarily tailored to the special needs of the disabled). Unfortunately, it is also obvious that those who are visually disabled (or blind) are less likely to be positioned to generate significant income when compared to their sighted peers. Ironically, those who are least able to afford expensive products are faced with the highest costs.

The architecture of the present invention is designed to preclude the necessity of a personal computer or cumbersome processing unit. The mechanical and logical architecture of the present invention lends itself to ease-of-use, portability, and low-cost manufacture.

The development of present invention was logically expanded to include the feature of language translation. The most basic operation mode of the proposed invention essentially reads and speaks text to the visually impaired in his or her native language. The architecture of the proposed invention is readily extensible by its nature. Therefore, the extension of the present invention to embody language translation is readily achievable. Thereby, the ability (mode) of the present invention to assist the visually impaired is actually a subset of the language-translating invention.

The extensibility of the present invention to include language translation is an essential ingredient to the commercial viability of the invention to be marketed and used in a visual-assistance context. As previously mentioned, a survey of visual-assistance products presently available in the market place indicates the extreme cost of these products. An analysis of the cost-intensive nature of these products shows that two essential ingredients are missing from those products currently available to the visually impaired: 1) lack of consumer product orientation and, 2) limited production volumes.

### BRIEF SUMMARY OF THE INVENTION

The present invention is a digital imaging apparatus, or appliance, with two operating modes. The extensible design of the present invention lends itself to dual-purpose utility as 1) a language-translating device and, 2) a reading assistant for the visually impaired. The present invention serves the language translation needs of those in foreign language circumstances, as well as the visually impaired (visually handicapped) needing assistance in reading words in their own, native language. The present invention is multi-functional in that is converts physical text to speech in either native or foreign language(s). This present invention is most unique in its language translation ability.

Key features of the present invention are summarized herein. The actual manufacture of the present invention would be tailored to the intended utility (mode) of the specific product. Although the architecture of the present invention allows for duality, it may be most cost-effective in the manufacture of the product to include or preclude certain features in manufacture. The detailed description of the invention (following sections) will highlight these distinctions.

The present invention will be small by comparison to products in the market today. The present invention would be similar in size and appearance to a common point-and-shoot 35 mm film camera. The present invention will be robust, portable, and handheld.

The present invention is multi-functional with text to speech in native or foreign language(s). There is no restriction to which language may be considered “native” and those considered “foreign”. Virtually any language could be considered as native, and any others considered as foreign. The present invention could support more than one foreign language.

The present invention includes a removable memory module as a key feature. Memory modules of varying capacity (available commercially from third-parties, apart from this invention) offer the user the ability to easily change or add languages to the translator. A logical choice for removable, rewrite able memory would be Compact Flash. The present invention is not limited to, or restricted by the type of memory. Other potential memory media include Smart Media and Memory Stick. (All three memory types are presently used in consumer digital still cameras.)

The present invention is upgradeable. Removable memory modules not only offer additional language capability, but also the convenient ability to update or upgrade the embedded processor and microcontroller(s) with improved and faster firmware and algorithms. Updates can be made to optical character recognition (OCR), text-to-speech (TTS), device operation (input/output), image processing science, and other device functionality.

The present invention is designed to be an affordable, low-cost device based upon relatively common consumer-electronics architecture and components. Manufacture of the present invention will leverage production quantities and economies of scale from other high-volume production products.

The present invention does not require physical contact with the object to be read or translated. The user need not touch or come into contact with the object of interest. For the visual-assist mode, auto-focus optics is an essential feature whereas zoom optics is most relevant to the language translation mode.

The present invention is a product with a common look and feel to the consumer. The present invention uses a point-and-shoot camera paradigm for instant familiarity and ease of use. The present invention looks, feels, and operates like a common film camera, yet it is not. The present invention does not capture a picture nor store images. (The present invention does not operate in color, rather it is based upon a monochrome image sensor.)

The present invention improves upon current art as it addresses the issues of: 1) consumer product orientation and, 2) production volume. The present invention leverages prior art and production competencies well established in the photographic industry. The present invention integrates a logical architecture and utilizes components commonly used in many of today's commercial digital still cameras. The development tools required to productize the present invention are common to those used in many consumer electronic products. The present invention would find its greatest appeal as a consumer-oriented language translation device, appealing to a large worldwide market. The visual-assistance mode/version of the present invention would enjoy the economies of scale of the large manufacturing quantities of the language translating mode/device thereby offering an affordable product to those who are visually impaired.

The architecture of the present invention is designed to preclude the necessity of a personal computer or cumbersome processing unit. The mechanical and logical architecture of the present invention lends itself to ease-of-use, portability, and low-cost manufacture.

Visual assistance devices available in the market place today are large, expensive and computer based. This present invention device is small, portable, handheld, and low cost. Portability is an essential feature to the utility of the device.

The present invention solves a major roadblock in the utility and functionality of present art. The present invention is device requiring no contact, unlike scanner-based concepts. With the present invention the user need not touch nor come into contact with the object of interest. This allows for the utility of reading signs, posters, restaurant menus, phone books, objects on a grocery store shelf, and so forth. Auto-focus optics enable the non-contact ability, especially for the visually impaired. Zoom optics enhance the present inventions utility in the language translation mode as the user can zoom in to distant objects and exercise precise control over the text objects to be translated.

In summary, the present invention is a digital imaging apparatus, or appliance, with two operating modes. The extensible design of the present invention lends itself to dual-purpose utility as 1) a language-translating device and, 2) a reading assistant for the visually impaired. The manufacture of each device will include those features relevant to each.

### BRIEF DESCRIPTION OF THE SEVERAL VIEWS OF THE DRAWING

FIG. 1 is an isometric drawing of the front of the Voice-Enabled Digital Camera that depicts the apparatus operating in its most basic mode. In this scenario an object (a clip from a newspaper) is imaged and the text that is “seen” by the camera is recognized and converted to audible speech.

FIG. 2 is an isometric drawing of the front of the Voice-Enabled Digital Camera that depicts the apparatus operating in its translation mode. In this scenario an object (a clip from a newspaper) is imaged and the text that is “seen” by the camera is recognized and converted to audible speech in another language (In this case, French). An optional viewer displays the translated speech in text form.

FIG. 3 is an isometric drawing of the back of the Voice-Enabled Digital Camera that depicts the apparatus operating in its translation mode. In this scenario an object (a clip from a newspaper) is imaged and the text that is “seen” by the camera is recognized and converted to audible speech in another language (In this case, French). An optional viewer displays the translated speech in text form. This view exhibits additional features and controls.

FIG. 4a and FIG. 4b are detailed drawings of the mode switch of the Voice-Enabled Digital Camera that depict the primary differences between the basic Voice-Enabled Digital Camera, and Voice-Enabled Digital Camera/Language Translator.

FIG. 5 is a functional block diagram that depicts the operational architecture of the Voice-Enabled Digital Camera/Language Translator.

### DETAILED DESCRIPTION OF THE INVENTION

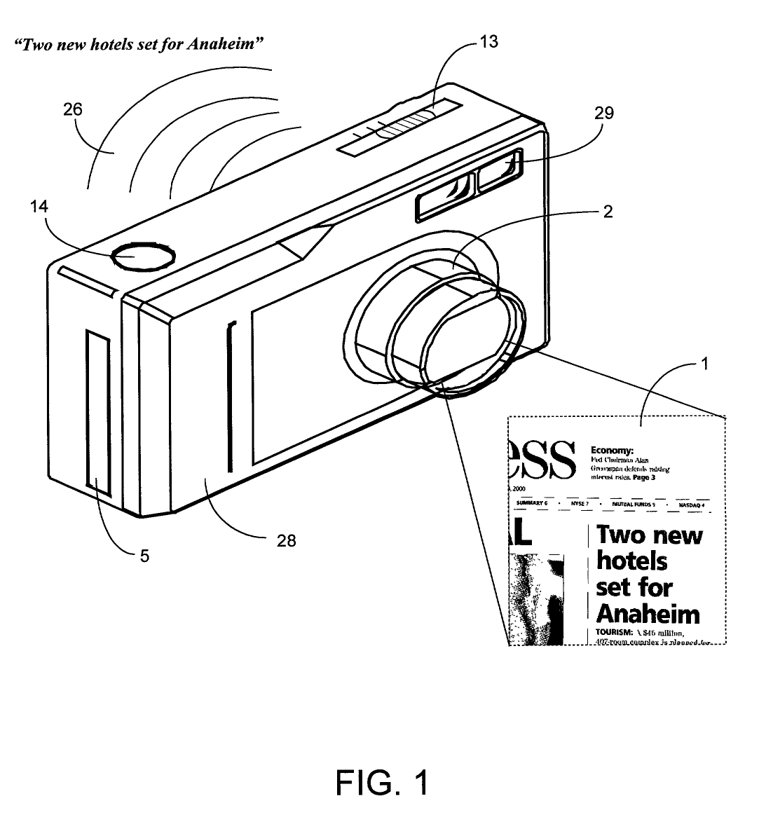

Reference is now made to FIG. 1, which illustrates the present invention operating in this visual-assist mode. In this case the present invention 28 is pointed at an object of interest 1. In this example the object of interest is a newspaper clipping. The present invention 28 is operated like a common point-and-shoot film camera.

The user turns on the device by sliding switch 13 to the ON position. If possible, the user looks through the viewfinder 29 to point the camera accurately. If the user is partially sighted, this feature is desirable since it allows for greater accuracy in selecting text of interest. (If the user is not sighted, the visual alignment step is omitted and the user may use the product in successive iterations to locate text of interest.)

The user presses the action button 14 as if it were a camera shutter button. The auto-focus zoom lens 2 (optionally a fixed-focus auto focus lens) focuses on the object of interest. The mechanism for auto focus used here is common to 35 mm point-and-shoot film cameras. The reason for auto focus is to improve recognition accuracy, especially in the case of the non-sighted individual who has little or no knowledge of the relative proximity of the targeted object.

After the auto focus lens has determined the proper focus, the object is electronically imaged and processed. (Described in the following paragraphs.) The processed image is recognized as text characters, algorithmically determined as words, synthesized to speech, and spoken via a speaker (or optional headphones) as an audible sound wave 26.

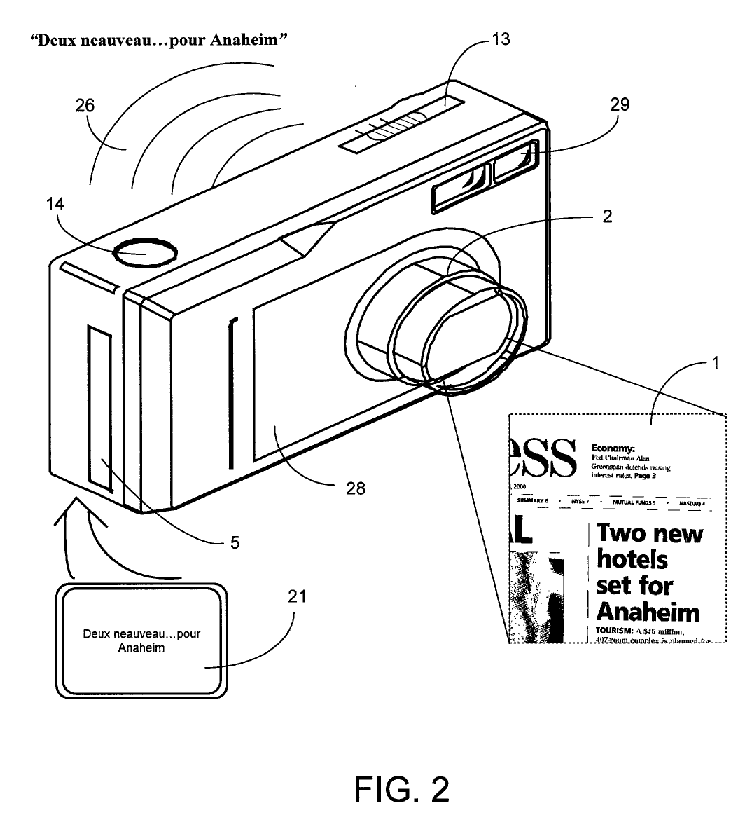

Reference is now made to FIG. 2, which illustrates the present invention operating in this language translation mode. In this case the present invention 28 is pointed at an object of interest 1. In this example the object of interest is a newspaper clipping written in the English language. The present invention 28 is operated like a common point-and-shoot film camera.

The user turns on the device by sliding switch 13 to the ON position. The user has a choice of languages modes. The user may elect to have the audible output in either his/her native language (the default language of the manufactured device) or he/she may select an alternate language. In manufacture the device would most likely host one “native” language and one “foreign” language. The native language is the language in which the device “reads”, or recognizes text. A foreign (alternate) language is selectable by the user as audible output.

In FIG. 2 the illustration shows a device where English is the “native” language and French is the alternate language. The device in this illustration would be useful to a French speaker visiting an English speaking country, or reading a document or text-based object that is written or printed in the English language. The device in the illustration may also be of interest to an English-speaking student desiring to learn the French language. An English speaker traveling to a France (as an example) would select a device with French as its native language and English as the “foreign” or “alternate” language. While traveling in France the English speaker could enjoy the benefits of both translation to his/her native English, as well as a guide pronunciation of words in French.

Additional languages(s) may be stored in the device program memory (explained in following paragraphs) to the extent of available memory. The optional expansion memory module 5 allows the user to add additional (or multiple) “alternate” languages.

To perform a translation, the user looks through the viewfinder 29 to point the camera accurately. For a greater degree of selection and control, the user may zoom in- or out- as desired using the zoom control ring on the lens 2. The user presses the action button 14 as if it were a camera shutter button. The auto-focus nature of the lens 2 focuses on the object of interest. The mechanism for auto focus used here is common to 35 mm point-and-shoot film cameras. After the auto focus lens has determined the proper focus, the object is electronically imaged and processed. (Described in the following paragraphs.) The processed image is recognized as text characters, algorithmically determined as words, converted to the selected language, synthesized to speech, and spoken via a speaker (or optional headphones) as an audible sound wave 26 in the selected language.

FIG. 2 also illustrates an optional text display 21. This optional feature will display the text in the translated language in addition to (or instead of) the audible output.

The language translation device illustrated in FIG. 2 is more feature-rich than the device manufactured as a visual-assist device and described in FIG. 1. If may be noted, however, that the more elaborate language translation device can perform the visual assist function by simply sliding mode switch 13 to the “Native” position. In this respect the two devices are virtually identical, while appealing to two vastly different and distinct groups of users. In fact, the visual-assist device is a subset of the language translator.

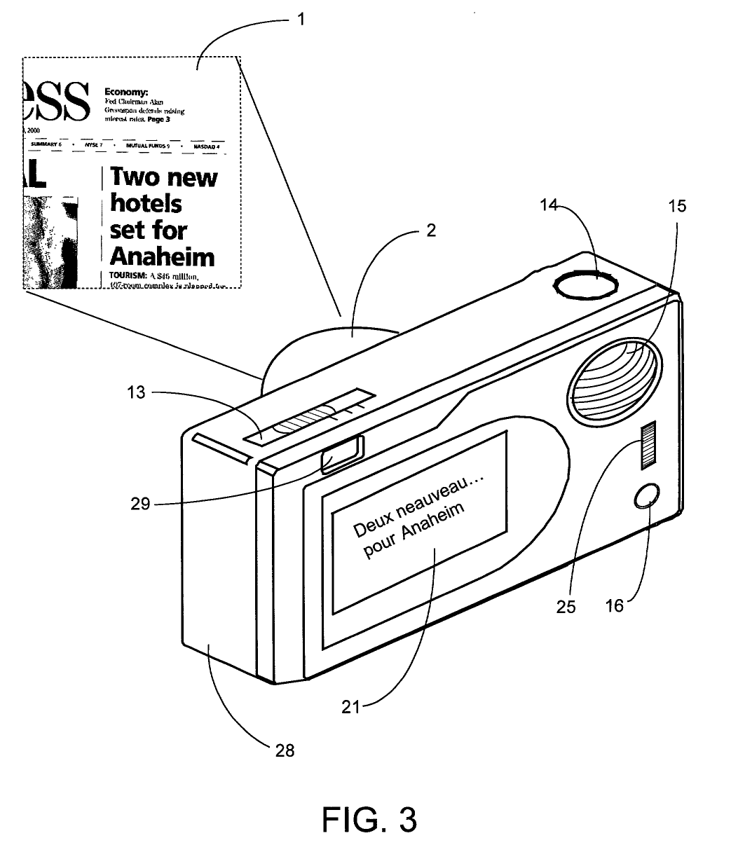

Reference is now made to FIG. 3, which illustrates the backside of the present invention 28 operating in the language translation mode with the optional text display screen 21. Additional features illustrated in FIG. 3 include an integral audio speaker 15, and optional headphone/earphone jack 16, and audio volume control 25.

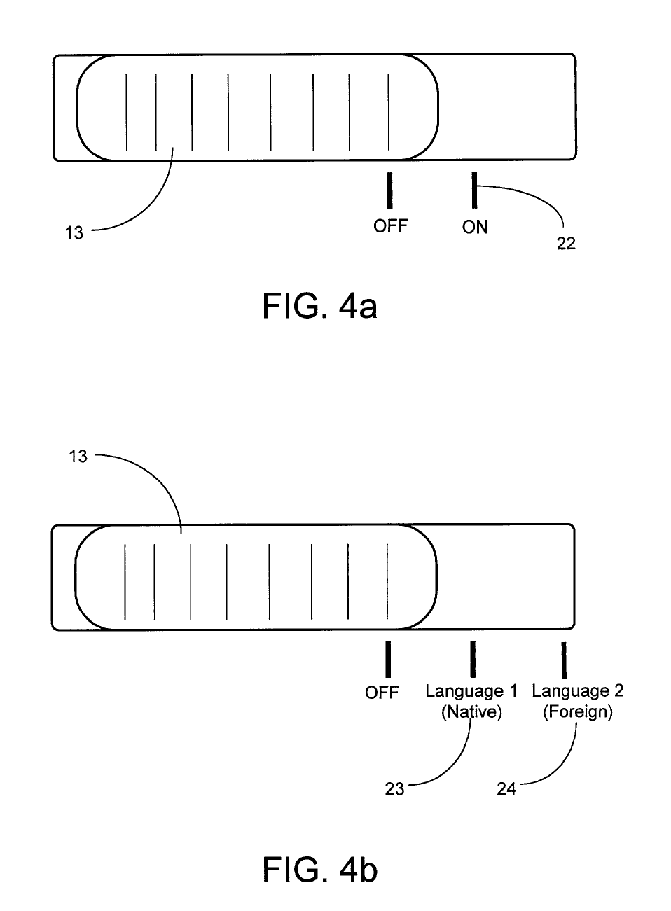

Reference is now made to FIG. 4a and FIG. 4b, which illustrate the mode switches 13 of the present invention 28. FIG. 4a indicates the relative simplicity of the mode switch 13 for the visual-assist device with only one choice of language—the native language of the device as manufactured. FIG. 4b indicates the mode switch 13 for language translation device with the choice of languages.

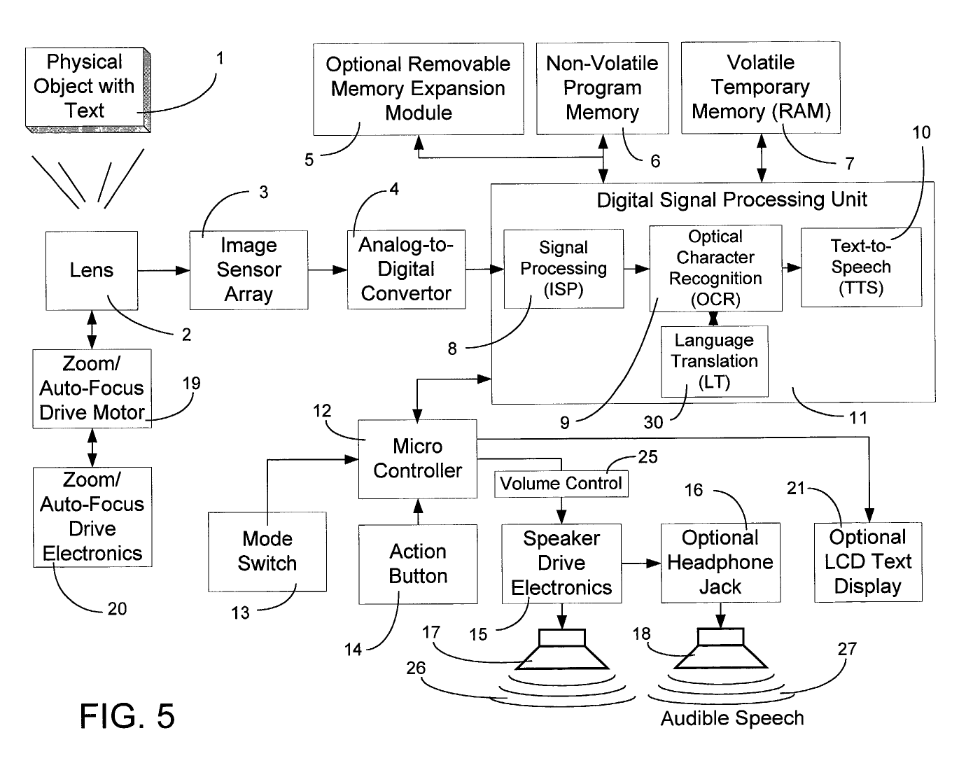

Reference is now made to FIG. 5, which illustrates the underlying functional components in a block diagram. The object with text 1 is an object within visible range of the device. This is a distinct feature of the present invention 28. The object of interest need not be within close physical proximity nor is there a requirement to contact the object (as with a scanner). The optional zoom lens 2 along with the drive motor 19 and drive electronics 20 extends the “reach” of the device, allowing for the ability to decipher distant objects. The ability to zoom in- and out- is a key feature of the language translator as this feature allows the user to frame their subject of interest. By framing the object of interest, unnecessary visual noise and clutter is eliminated from the scene, thereby increasing recognition accuracy and product utility. In the visual-assist mode, zoom may be of limited utility.

Auto focus optics 2 and associated drive motor 19 and drive electronics 20 are used in conjunction with the optional zoom capability. (When zoom optics are incorporated, the zoom and auto focus drives and drive electronics are integral to one another.) Auto focus is another key feature of the present invention.

The image sensor array 3 is the “eye” of the system. Although the sensor is a critical component, it is not unique to this invention. The image sensor may be either a CMOS or CCD monochrome-imaging array. Whereas digital still and video cameras commonly use CMOS and CCD arrays, the present invention is unique in its specification of the imaging array. Consumer digital cameras and video cameras on the market utilize colorized, filtered imaging sensors whereas the present invention uses a monochrome device without infrared filtering. The present invention uses a monochrome sensor that does not utilize a classic “bayer-pattern”, as do other camera devices which strive for color accuracy. The present invention need not process color. Therefore, the use of a non-filtered/non-colorized monochrome sensor offers maximum possible sensor resolution and sensitivity, lower manufacturing cost, and sensitivity in the infrared (IR) spectral region. IR sensitivity will assist the present invention to “see” in conditions of low light.

The present invention may utilize either a CMOS or CCD array 3. CMOS will be the preferred array-type as it offers lower production costs and CMOS offers significant reductions in power consumption relative to CCD arrays. Power consumption for a battery-powered appliance such as the present invention is key to product utility and consumer acceptance.

The analog-to-digital converter(s) 4 (ADC) are common to in any imaging product. Whereas most commercial imaging products (digital cameras) utilize 10-bit ADC, the present invention will likely use 12-bit ADC for purposes of increasing system signal-to-noise ration (SNR). Increasing SNR will improve character recognition and further improve low light level performance.

The “engine” of the present invention is embodied in the digital signal processing (DSP) unit 11 which integrates the image signal processing (ISP) 8, optical character recognition 9, and text-to-speech (TTS) 10. The precise implementation of the DSP unit is to be determined at the time of detailed engineering prior to manufacture since this is an area of rapid component development.

The (DSP) unit 11 will integrate ISP 8, OCR 9, and TTS 10 to the maximum extent possible and practical. A real-time operating system (RTOS) will be selected (example: Nucleus, VxWorks, pSOS, ByteBOS, etc.) and OCR 9 and TTS 10 applications will be ported or compiled for the select DSP and RTOS. If the DSP cannot host all desired functionality, additional components (programmable logic device, or gate-array, boot PROM) can be incorporated into the final design prior to manufacture without affecting the overall system concept of the present invention.

The present invention will incorporate three types of memory. Non-volatile program memory 6 will store and retain the algorithms, tables, and program code required for OCR 9, language translation 30 (LT), and TTS 10. A second type of memory will be volatile temporary memory space 7, analogous to Random Access Memory (RAM). RAM will be used for temporary storage of the image captured by the image sensor 3. RAM will serve as temporary working space as the image is processed, recognized, translated (if that mode is selected),and finally converted to speech. The actual RAM memory type will most likely be SDRAM (Synchronous dynamic RAM) because of its read/right speed. Optional removable memory 5 will allow the user to add additional language capability and introduce upgrades and enhancements to the reprogrammable system components. Whereas DSP 11 functionality is common to many electronic devices the unique integration of ISP 8, OCR 9, LT 30, and TTS 10 render the present invention truly unique and distinct from all other known devices and products.

The present invention will utilize a microcontroller 12 to manage DSP 11, memory 5/6/7, and input/output (I/O). (I/O will be discussed in the following section.) The microcontroller 12 is a common component used in many consumer electronics products. The present invention will utilize several inputs and outputs (I/O). The inputs include the mode switch 13 (also described in FIG. 4a and FIG. 4b), and the action button 14. Outputs (and output controls) include volume control 25, speaker drive electronics 15, headphone jack 16, and optional text display 21.

The mode switches 13 of the present invention 28 are illustrated in FIG. 4a and FIG. 4b. FIG. 4a indicates the relative simplicity of the mode switch 13 for the visual-assist device with only one choice of language—the native language of the device as manufactured. FIG. 4b indicates the mode switch 13 for language translation device with the choice of languages.

The action button 14 is analogous to the shutter button of a common film camera. Pressing the action button 14 activates the auto focus routine and initiates the image capture and processing sequence. This action ultimately results in audible speech 26 from the integral speaker 17, as controlled by the volume controller 25 (a simple variable resistance/potentiometer device). An alternate path for audible speech 27 to an optional external earphone/headphone 18 is also provided and it also controlled by the volume controller 25. The optional earphone/headphone jack 16 offers the user a discrete and private means by which audio may be presented.

Finally, the optional text display 21 offers another mechanism for displaying the results of the language translation. This feature would not be applicable to the visual-assist mode, but may be of interest as an option to language translation users.

We claim:

1. Apparatus of extensible design which embodies a unique integration of hardware, software, and embedded firmware in a device that “reads” physical objects (text-based) and “speaks” the words in either native or foreign languages, offering dual-purpose utility as a) language-translation device and/or, b) a reading assistant for the visually impaired; serving the language translation needs of those in foreign language circumstances, as well as the visually impaired (visually handicapped) needing assistance in reading words in their own, native language.

2. Apparatus according to claim 1 and wherein the device does not require physical contact with the object to be read or translated utilizing auto-focus zoom optics for enhanced accuracy and utility

3. Apparatus according to claim 1 with a common look and feel, using a common point-and-shoot camera paradigm for instant familiarity and ease of use.

4. Apparatus according to claim 1 which is upgradeable and extensible through the use of removable memory modules offering additional language capability as well as the convenient ability to update or upgrade the embedded processor and microcontroller(s) with improved and/or updated firmware and algorithms for optical character recognition, text-to-speech, device operation (input/output), image processing science, language translation, and other device functionality.
